(19) United States
(12) Patent Application Publication
(10) Pub. No.: US 2024/0254337 A1
(43) Pub. Date: Aug. 1, 2024

(54) PAPRIKA EMULSIFIED DYE PREPARATION AND METHOD FOR PRODUCING SAME

(71) Applicant: SAN-EI GEN F.F.I., INC., Toyonaka-shi, Osaka (JP)

(72) Inventors: Takaaki ITO, Osaka (JP); Masayuki NISHINO, Osaka (JP)

(21) Appl. No.: 17/998,465

(22) PCT Filed: May 14, 2021
(86) PCT No.: PCT/JP2021/018438

§ 371 Date: Nov. 10, 2022

(30) Foreign Application Priority Data
May 15, 2020 (JP) 2020-086118

(51) Int. Cl. C09B 61/00; A23L 5/43; C09B 67/46

(52) U.S. Cl. CPC C09B 61/00; A23L 5/43; C09B 67/0089

(57) ABSTRACT

A paprika emulsified dye preparation exhibiting a red color is provided. Specifically, a paprika emulsified dye preparation, which contains a paprika dye, an oil-based solvent, water, and an emulsifier, and has the following characteristics: a color density per mass percent of an oil phase is 1500 CV or more; a volume-based median diameter (D50) of emulsified particles is 1 to 3 μm; and a hue is 25 to 34 is provided.

### TECHNICAL FIELD

The present invention relates to a paprika emulsified dye preparation, a method for producing the same, and the like.

### BACKGROUND ART

A paprika dye is known as a relatively inexpensive red natural dye, and is used for coloring various red foods such as crab sticks. However, a conventional paprika dye preparation has a drawback that it exhibits an orange to yellow color and cannot exhibit a red color by itself. Therefore, for example, a red coloration method using it in combination with a red yeast rice pigment, or the like has been used.

In addition, it is known that when the size of emulsified particles contained in the paprika dye preparation is small, the preparation exhibits an orange color, so that a technique for preparing a paprika dye preparation exhibiting a red color by increasing the size of emulsified particles was developed (PTLs 1 and 2). However, when the size of emulsified particles is increased, problems that the color tone becomes dark, the required amount of the dye used for coloration increases, etc. have arisen.

Further, in order to prepare a paprika dye preparation in which the dye does not transfer (color transfer) to a film for packaging a fishery paste product colored with a paprika dye, an oil-in-water emulsified composition containing a paprika dye, in which an oil phase containing a paprika dye and a lipophilic food emulsifier and an aqueous phase containing a hydrophilic polymer compound and water are emulsified, is known (PTL 3). However, as will be described later, the dye preparation described in the document is not intended for strong red coloration, and the color tone was orange.

### CITATION LIST

### Patent Literature

PTL 1: JP2001-252043A

PTL 2: JPH05-316995A

PTL 3: JP2006-109792A

### SUMMARY OF INVENTION

### Technical Problem

An object of the invention is to provide a paprika emulsified dye preparation having a small particle size and exhibiting a red color, and a method for producing the same.

### Solution to Problem

The present inventors conducted intensive studies to achieve the above object, and found that by setting the color density per mass percent of an oil phase to 1500 CV or more when preparing a paprika emulsified dye preparation, the dye preparation exhibits a red color even if the particle size is small, and then made further improvements and completed the invention.

The present invention has been completed through further studies based on such findings, and has the following embodiments.

[1] A paprika emulsified dye preparation, containing a paprika dye, an oil-based solvent, water, and an emulsifier, and having the following characteristics:
a color density per mass percent of an oil phase is 1500 CV or more;
a volume-based median diameter (D50) of emulsified particles is 1 to 3 um; and
a hue is 25 to 34.

[2] The preparation according to [1], characterized by further having a chroma of 30 to 44.

[3] The preparation according to [1] or [2], wherein the emulsifier is at least one type selected from the group consisting of gum arabic, a sucrose fatty acid ester, a sorbitan fatty acid ester, a glycerol fatty acid ester, a polyglycerol fatty acid ester, polyglycerol polyricinoleate, lecithin, gum ghatti, and low-molecular weight gum ghatti.

[4] The preparation according to any one of [1] to [3], wherein a content of the oil phase with respect to the total amount of the paprika emulsified dye preparation is 10 to 40 mass %.

[5] A method for producing a paprika emulsified dye preparation, including:
a step of mixing a paprika dye and an oil-based solvent, thereby preparing an oil phase having a color density per mass percent of the oil phase of 1500 CV or more; and
a step of mixing the oil phase and an aqueous phase containing water and an emulsifier, thereby preparing emulsified particles having a volume-based median diameter (D50) of 1 to 3 μm.

[6] The method according to [5], wherein the emulsifier is at least one type selected from the group consisting of gum arabic, a sucrose fatty acid ester, a sorbitan fatty acid ester, a glycerol fatty acid ester, a polyglycerol fatty acid ester, polyglycerol polyricinoleate, lecithin, gum ghatti, and low-molecular weight gum ghatti.

[7] The method according to [5], further including adding an oil-soluble emulsifier when preparing the oil phase.

[8] The method according to any one of [5] to [7], wherein the oil phase and the aqueous phase are mixed so that a content of the oil phase with respect to the total amount of the paprika emulsified dye preparation is 10 to 40 mass %.

### Advantageous Effects of Invention

A paprika emulsified dye preparation having a small particle size and exhibiting a red color is provided. Therefore, a product exhibiting a desired red color can be prepared by coloring the product using the paprika emulsified dye preparation of the invention.

### BRIEF DESCRIPTION OF DRAWINGS

FIG. 1 shows milk colored with a conventional paprika emulsified dye preparation and with a paprika emulsified dye preparation of the invention.

FIG. 2 shows ice cream colored with a conventional paprika emulsified dye preparation and with a paprika emulsified dye preparation of the invention.

FIG. 3 shows milk colored with various dye preparations (Example 19, Comparative Example 9, Comparative Example 5, Comparative Example 10, and Comparative Example 11 from the left).

### DESCRIPTION OF EMBODIMENTS

Hereinafter, each embodiment included in the invention will be described in more detail.

### Emulsified Preparation (Emulsified Dye Preparation)

The emulsified preparation of the invention can be prepared by separately preparing an oil phase containing a paprika dye having a given color density or more and an aqueous phase, mixing the both phases, and performing emulsification.

### Oil Phase

In the invention, the “oil phase” contains a paprika dye and an oil-based solvent, and may optionally contain an oil-soluble emulsifier, an oil-soluble oxidation inhibitor, and an oil-soluble flavor.

The content of the oil phase with respect to the total amount of the paprika emulsified dye preparation is not particularly limited and can be appropriately set within the range where the effect of the invention is exhibited. For example, it can be set to 10 to 40 mass %. It is preferably 11 to 35 mass %, and more preferably 12 to 30 mass %.

### Paprika Dye

The paprika dye is not particularly limited as long as it is a dye extracted from a fruit of paprika of the Solanaceae family with an oil or fat or an organic solvent. For example, as the paprika dye, one obtained by extraction from a fruit of red pepper of the Solanaceae family (Capsicum annuum LINNE) with an oil or fat at hot, one obtained by extraction with hexane or ethyl alcohol at room temperature to slightly warm, one obtained by extraction with carbon dioxide under pressurization at warm, one obtained by removing a pungent component therefrom with carbon dioxide under pressurization at warm, or the like is exemplified.

The form of the paprika dye used in the paprika emulsified dye preparation of the invention is not particularly limited, and may be, for example, a liquid form (such as a solution form or a suspension form) , a paste form, a solid form (such as a powder form), or the like.

The color density (CV) of the paprika dye used in the paprika emulsified dye preparation of the invention is not particularly limited, but is exemplified by 100,000 CV or more. One having a color density of 200,000 CV or more may be used, and one having a color density of 300,000 CV or more may be used.

The content of the paprika dye with respect to the total amount of the paprika emulsified dye preparation is not particularly limited as long as the color density per mass percent of the oil phase contained in the paprika emulsified dye preparation is 1500 CV or more. The content of the paprika dye with respect to the total amount of the paprika emulsified dye preparation can be expressed by the color density (CV) of the paprika dye with respect to the total amount of the paprika emulsified dye preparation, and can be appropriately set, for example, within a range of 15,000 to 60,000 CV. It is preferably 25,000 to 55,000 CV, and more preferably 30,000 to 50,000 CV.

The paprika emulsified dye preparation may contain another oil-soluble dye in addition to the paprika dye, and may not contain another oil-soluble dye. Examples of such another oil-soluble dye include astaxanthin and tomato lycopene.

### Oil-Based Solvent

The oil-based solvent used in the invention can preferably be a solvent that can be used as a solvent for an oil-soluble material such as the paprika dye, specifically, a solvent compatible with an oil-soluble material such as the paprika dye.

The oil-based solvent used in the invention is preferably an edible substance that can be added to a food or drink, or a substance that can be applied to the human body as a perfume or cosmetic product.

Examples of the oil-based solvent used in the invention include vegetable oils and fats such as rapeseed oil, corn oil, rice oil, palm oil, soybean oil, olive oil, jojoba oil, coconut oil, safflower oil, sunflower oil, sesame oil, perilla oil, an elemi resin, and a mastic resin;
animal oils and fats such as beef tallow and lard;
sucrose acetate isobutyrate (SAIB), rosin, a dammar resin, an ester gum, a glycerol fatty acid ester, a triglyceride, and the like.

These can be used each alone or two or more types thereof can be used in any combination.

Examples of the oil-based solvent include preferably vegetable oils and fats, sucrose acetate isobutyrate (SAIB), a glycerol fatty acid ester, and a triglyceride, and more preferably vegetable oils and fats, a glycerol fatty acid ester, and a triglyceride (more preferably a medium-chain fatty acid triglyceride (MCT) having excellent oxidation stability).

The medium-chain fatty acid triglyceride refers to a triacylglycerol composed of a medium-chain fatty acid having about 6 to 12 carbon atoms, preferably 6 to 10 carbon atoms, and more preferably 8 to 10 carbon atoms. Specifically, it includes caprylic acid triglyceride, capric acid triglyceride, caprylic/capric acid triglyceride, and a mixture thereof.

The content of the oil-based solvent with respect to the total amount of the paprika emulsified dye preparation is not particularly limited and can be appropriately set within the range where the effect of the invention is exhibited. For example, it can be set to 0.05 mass % to 8 mass %. It is preferably 0.1 to 7.5 mass %, and more preferably 0.2 to 7 mass %.

### Oil-Soluble Emulsifier

Examples of the oil-soluble emulsifier that can be used in the “oil phase” of the invention include lecithin, and a sucrose fatty acid ester, a sorbitan fatty acid ester, a glycerol fatty acid ester, a polyglycerol fatty acid ester, a propylene glycol fatty acid ester, and polyglycerol polyricinoleate each having an HLB value within a range of about 0 to 6. The HLB values of the sucrose fatty acid ester, the sorbitan fatty acid ester, the glycerol fatty acid ester, the polyglycerol fatty acid ester, the propylene glycol fatty acid ester, and the polyglycerol polyricinoleate used in the “oil phase” may be 0 to 5, 0 to 4, or 0 to 3. Further, with respect to a sucrose fatty acid ester having an HLB value close to 0 (for example, sucrose acetate isobutyrate (SAIB)) and a glycerol fatty acid ester, the use thereof may sometimes overlap with the above-mentioned use as the oil-based solvent.

In the invention, it is not essential to use the oil-soluble emulsifier, but for example, when a naturally derived polysaccharide such as gum arabic is used as a water-soluble emulsifier described later, the combination use with the oil-soluble emulsifier has an advantage in improving the long-term stability of the emulsified preparation.

In the invention, lecithin may be used when preparing the aqueous phase or may be used when preparing the oil phase, as described later. Examples of the lecithin that can be used when preparing the oil phase of the invention include plant lecithin (such as soybean lecithin, corn lecithin, rapeseed lecithin, and sunflower lecithin), egg yolk lecithin, fractionated lecithin, enzyme-treated lecithin, and enzymatically decomposed lecithin. Among them, plant lecithin can be preferably used, and sunflower lecithin can be more preferably used. Among these, one type can be used alone or two or more types can be used in combination. The fractionated lecithin means lecithin obtained by fractionating a specific component from plant lecithin or egg yolk lecithin by utilizing the difference in solubility using an organic solvent such as ethanol. Further, the enzyme-treated lecithin means lecithin obtained by allowing phospholipase D to act on a mixture of “plant lecithin” or “egg yolk lecithin” and glycerol, and contains phosphatidylglycerol as a main component. Further, the enzymatically decomposed lecithin means lecithin obtained by adjusting the pH of “plant lecithin” or “egg yolk lecithin” with water or an alkaline aqueous solution, and thereafter performing enzymatic decomposition at room temperature to warm, and then performing extraction with ethanol, isopropyl alcohol, or acetone, and contains lysolecithin and phosphatidic acid as main components.

A fatty acid constituting the sucrose fatty acid ester, the sorbitan fatty acid ester, the glycerol fatty acid ester, the polyglycerol fatty acid ester, and the polyglycerol polyricinoleate that can be used as the oil-soluble emulsifier in the invention is not particularly limited, but examples thereof include saturated or unsaturated fatty acids having about 12 to 20 carbon atoms such as lauric acid, myristic acid, palmitic acid, palmitoleic acid, stearic acid, oleic acid, linoleic acid, linolenic acid, ricinoleic acid, and arachidic acid. The fatty acid constituting the sucrose fatty acid ester, the sorbitan fatty acid ester, the glycerol fatty acid ester, the polyglycerol fatty acid ester, and the polyglycerol polyricinoleate may be one type of fatty acid or two or more types of fatty acids selected from these.

Specific examples of the sucrose fatty acid ester that can be used as the oil-soluble emulsifier in the invention include sucrose laurate, sucrose myristate, sucrose palmitate, sucrose stearate, sucrose oleate, and an acetylated sucrose fatty acid ester each having a monoester content of 30% or less. It is preferably an acetylated sucrose fatty acid ester. The upper limit of the monoester content in the sucrose fatty acid ester is not particularly limited, but may be 25% or less, or 20% or less. Further, the lower limit of the monoester content is also not particularly limited, but may be 5% or more, or 10% or more. Among these, one type can be used alone or two or more types can be used in combination.

Specific examples of the sorbitan fatty acid ester that can be used as the oil-soluble emulsifier in the invention include sorbitan monostearate and sorbitan monooleate. Among these, one type can be used alone or two or more types can be used in combination.

Specific examples of the glycerol fatty acid ester that can be used as the oil-soluble emulsifier in the invention include monoglycerol oleate and monoglycerol laurate. Among these, one type can be used alone or two or more types can be used in combination.

The average degree of polymerization of the polyglycerol fatty acid ester that can be used as the oil-soluble emulsifier in the invention is not particularly limited and can be appropriately set within the range where the effect of the invention is exhibited. For example, it can be set to about 2 to 10.

Specific examples of such a polyglycerol fatty acid ester include pentaglycerol hexastearate, decaglycerol pentaoleate, decaglycerol pentastearate, decaglycerol decaoleate, and decaglycerol decastearate. Among these, one type can be used alone or two or more types can be used in combination.

Specific examples of the propylene glycol fatty acid ester that can be used as the oil-soluble emulsifier in the invention include propylene glycol fatty acid monostearate and propylene glycol fatty acid distearate.

Specific examples of the polyglycerol polyricinoleate that can be used as the oil-soluble emulsifier in the invention include tetraglycerol-condensed ricinoleate, pentaglycerol-condensed ricinoleate, and hexaglycerol-condensed ricinoleate. Among these, one type can be used alone or two or more types can be used in combination.

The content of the oil-soluble emulsifier with respect to the total amount of the paprika emulsified dye preparation is not particularly limited and can be appropriately set within the range where the effect of the invention is exhibited. For example, it can be set to 0.05 to 5 mass %. It is preferably 0.08 to 4 mass %, and more preferably 0.1 to 3 mass %.

### Oil-Soluble Oxidation Inhibitor

Examples of the oil-soluble oxidation inhibitor that can be used in the “oil phase” of the invention include vitamins such as an ascorbyl fatty acid ester and vitamin E (such as tocopherol, tocotrienol, and tocopherol acetate); and oil-soluble polyphenols such as a bayberry extract. In the invention, it is not essential to use the oil-soluble oxidation inhibitor, but the use of the oil-soluble oxidation inhibitor has an advantage that a decrease in the color density of the paprika dye is suppressed, and further, the oxidation or decomposition of an oil or fat in the oil phase is prevented so that the generation of an offensive smell (oily smell) can be prevented.

The content of the oil-soluble oxidation inhibitor with respect to the total amount of the paprika emulsified dye preparation is not particularly limited and can be set to 0.1 mass % or more, and is preferably 0.3 mass % or more. The upper limit of the content of the oil-soluble oxidation inhibitor is also not particularly limited, but is for example, 5 mass % or less, and preferably 3 mass % or less with respect to the total amount of the paprika emulsified dye preparation.

### Oil-Soluble Flavor

In the invention, it is not essential to use the oil-soluble flavor, but the use of the oil-soluble flavor has an advantage that a smell (oily smell) derived from an oil or fat in the oil phase can be prevented from being perceived.

The oil-soluble flavor (including a fat-soluble flavor) that can be used in the invention needs only to be an oil-soluble or fat-soluble substance containing an aroma component, and is not limited to that extent only.

The oil-soluble flavor to be used in the invention is preferably an edible flavor that can be added to a food or drink, or a flavor that can be applied to the human body as a perfume or cosmetic product.

Examples of the flavor include
an extract obtained from an animal or plant origin natural raw material by non-volatile solvent extraction, volatile solvent extraction, supercritical extraction, or the like, or a combination thereof;
an essential oil obtained by steam distillation, a squeezing method, or the like, and a natural flavor such as a recovered flavor;
a synthetic flavor, which is a flavor synthesized by a chemical method; and
a flavor base obtained by adding and/or dissolving such a flavor in an oil or fat and/or a solvent.

Examples of the form of the natural flavor include:
an extract such as an absolute, an essence, or an oleoresin;
a squeezed liquid obtained by cold pressing or the like; and
an extract obtained using an alcohol or an extract obtained using a mixed liquid of water and an alcohol (as such an extract, a so-called tincture).

Specific examples of such a flavor include:
citrus-based essential oils such as orange oil, lemon oil, grapefruit oil, lime oil, and mandarin oil;
flower essential oils (or absolutes) such as lavender oil;
essential oils such as peppermint oil, spearmint oil, and cinnamon oil;
essential oils (or oleoresins) of spices such as all spices, anise seeds, basil, laurel, cardamom, celery, cloves, garlic, ginger, mustard, onion, paprika, parsley, and black pepper;
synthetic flavors such as limonene, linalool, geraniol, menthol, eugenol, and vanillin;
extracted oils derived from beans such as coffee, cacao, vanilla, and roasted peanuts;
essentials derived from tea such as black tea, green tea, and oolong tea; and
synthetic flavor compounds.

Among these flavors, one type can be used alone, but generally, two or more types are used in any combination as a blended flavor.

The “flavor” as used herein is defined as a concept including not only a flavor composed of a single compound but also such a blended flavor.

The content of the oil-soluble flavor with respect to the total amount of the paprika emulsified dye preparation is not particularly limited and can be set to 0.01 mass % or more, and is preferably 0.1 mass % or more. The upper limit of the content of the oil-soluble flavor is also not particularly limited, but is, for example, 5 mass % or less, and preferably 3 mass % or less with respect to the total amount of the paprika emulsified dye preparation.

### Aqueous Phase

In the invention, the “aqueous phase” is a portion other than the “oil phase” and is a phase obtained by mixing a water-soluble emulsifier, a polyhydric alcohol, a pH adjusting agent such as an organic acid and/or an inorganic acid, and an inorganic salt, each of which is a hydrophilic material having high solubility in water, and ion exchanged water or the like.

The content of the aqueous phase with respect to the total amount of the paprika emulsified dye preparation is not particularly limited and can be appropriately set within the range where the effect of the invention is exhibited. For example, it can be set to 60 to 90 mass %. It is preferably 65 to 89 mass %, and more preferably 70 to 88 mass %.

### Water-Soluble Emulsifier

Examples of the water-soluble emulsifier include natural polysaccharides (natural emulsifiers) having emulsifiability such as gum arabic, gum ghatti, low-molecular weight gum ghatti, pectin, and starch octenyl succinate; naturally derived emulsifiers such as lecithin and saponin; and synthetic emulsifiers such as a sucrose fatty acid ester and a polyglycerol fatty acid ester, each having an HLB within a range of 7 to 18. Among these, as the natural emulsifier, gum arabic is preferred, as the naturally derived emulsifier, lecithin is preferred, and as the synthetic emulsifier, a sucrose fatty acid ester having an HLB within a range of 7 to 18 is preferred. The natural emulsifier and the synthetic emulsifier may be used in combination. Among these, one type can be used alone or two or more types can be used in combination.

In the invention, the gum arabic is not limited as long as it is a generally available one. It is, for example, a polysaccharide obtained from a sap of a plant belonging to the genus Acacia, which is a plant of the Leguminosae family (such as Acacia Senegal or Acacia seyal), preferably Acacia senegal. Although the molecular structure of the gum arabic has not been completely clarified, it is known that galactose, arabinose, rhamnose, and glucuronic acid are contained as constituent sugars.

The gum arabic is commercially available, and as a product, for example, “Gum Arabic SD” manufactured by San-Ei Gen F.F.I., Inc. or the like can be exemplified.

In the invention, the gum ghatti is a polysaccharide derived from a sap (secreted fluid) of Anogeissus latifolia of the Combretaceae family and is a known polysaccharide as a food additive. As for the weight average molecular weight of gum ghatti generally distributed in the market, the molecular weight varies depending on the age of a tree from which the raw material is collected, the extraction method, or the like, but the weight average molecular weight of the gum ghatti used as the emulsifier is usually within a range of 1.1×10⁶ to 2×10⁶.

In the invention, the low-molecular weight gum ghatti is a polysaccharide derived from a sap (secreted fluid) of Anogeissus latifolia of the Combretaceae family in the same manner as the gum ghatti, but can be prepared by a step different from the gum ghatti, for example, by a heating decomposition treatment, an acid decomposition treatment, an enzymatic decomposition treatment, or the like (WO2018/062554) . The weight average molecular weight of the low-molecular weight gum ghatti is within a range of 0.03×10⁶ to 0.75×10⁶, and for example, 0.03×10⁶ or more, 0.04×10⁶ or more, 0.05×10⁶ or more, or 0.06×10⁶ or more, and 0.75×10⁶ or less, 0.60×10⁶ or less, 0.50×10⁶ or less, or 0.40×10⁶ or less.

Further, as the low-molecular weight gum ghatti, gum ghatti having a molecular weight distribution (the ratio of weight average molecular weight/number average molecular weight) (Mw/Mn) of 1.1 to 13 is also exemplified. The molecular weight distribution (the ratio of weight average molecular weight/number average molecular weight) (Mw/Mn) of the low-molecular weight gum ghatti is, for example, within a range of 1.1 to 10, within a range of 2.65 to 10, within a range of 1.1 to 8, within a range of 1.1 to 6, or within a range of 1.1 to 4.

The weight average molecular weight and the molecular weight distribution of the gum ghatti and the low-molecular weight gum ghatti are measured by the following method.

### Measurement Method of Molecular Weight and Molecular Weight Distribution

The molecular weight and the molecular weight distribution are measured by a GPC analysis under the following conditions.
Detector: RI
Mobile phase: 100 mM K₂SO₄
Flow rate: 1.0 mL/min
Temperature: 40° C.
Column: TSKgel GMPWXL 30 cm (Guard PWXL)
Injection: 100 μL
Pullulan standard: Shodex STANDARD P-82

The pectin that can be used in the invention may be derived from the cell wall of most plants such as vegetables and fruits, or fruit pulp or peel. In addition, the pectin is a polysaccharide containing about 300 to 1000 monosaccharide units, and the main monosaccharide unit is a D-galacturonic acid group. The length and complexity of the polysaccharide chain, as well as the order of the monosaccharide units in the chain, depend on the source of pectin.

The starch octenyl succinate that can be used in the invention is one obtained by subjecting starch derived from corn, potato, sweet potato, wheat, rice, glutinous rice, tapioca, sago palm, or the like serving as a raw material starch to a chemical treatment roughly classified into a decomposition treatment and an addition treatment. Among these starch raw materials, one type can be used alone or two or more types can be used in any combination.

In the invention, the lecithin that can be used when preparing the aqueous phase is the same as the lecithin used in the oil phase. Specific examples thereof include plant lecithin (such as soybean lecithin, corn lecithin, rapeseed lecithin, and sunflower lecithin), egg yolk lecithin, fractionated lecithin, enzyme-treated lecithin, and enzymatically decomposed lecithin.

In the invention, as the saponin that can be used when preparing the aqueous phase, a plant extract rich in saponin can also be used. Examples of the plant extract include a Quillaia extract, a Yucca extract, a Panax ginseng root extract, a soybean extract, a tea seed extract, and a Sophora japonica extract.

The HLB values of the sucrose fatty acid ester and the polyglycerol fatty acid ester that can be used as the water-soluble emulsifier in the invention are exemplified by about 7 to 18. The HLB values thereof may be 8 to 17, 9 to 16, 10 to 15, or 11 to 18.

A fatty acid constituting the sucrose fatty acid ester and the polyglycerol fatty acid ester that can be used as the water-soluble emulsifier in the invention is not particularly limited, but examples thereof include saturated or unsaturated fatty acids having about 12 to 20 carbon atoms such as lauric acid, myristic acid, palmitic acid, palmitoleic acid, stearic acid, oleic acid, linoleic acid, linolenic acid, and arachidic acid. The fatty acid constituting the sucrose fatty acid ester and the polyglycerol fatty acid ester may be one type of fatty acid or two or more types of fatty acids selected from these.

Specific examples of the sucrose fatty acid ester that can be used as the water-soluble emulsifier in the invention include sucrose monolaurate, sucrose monomyristate, sucrose monopalmitate, sucrose monostearate, and sucrose monooleate. It t is preferably sucrose monopalmitate or sucrose monostearate. Among these, one type can be used alone or two or more types can be used in combination.

The average degree of polymerization of the polyglycerol fatty acid ester that can be used as the water-soluble emulsifier in the invention is not particularly limited and can be appropriately set within the range where the effect of the invention is exhibited. For example, it can be set to about 6 to 10.

Specific examples of such a polyglycerol fatty acid ester include hexaglycerol monostearate, decaglycerol monostearate, decaglycerol monooleate, decaglycerol monomyristate, and decaglycerol monopalmitate. Among these, one type can be used alone or two or more types can be used in combination.

The content of the water-soluble emulsifier with respect to the total amount of the paprika emulsified dye preparation is not particularly limited and can be appropriately set within the range where the effect of the invention is exhibited. For example, it can be set to 1 to 20 mass %. It is preferably 2 to 19 mass %, and more preferably 3 to 18 mass %.

### Polyhydric Alcohol

The emulsified preparation of the invention can preferably contain a polyhydric alcohol as a preservative and/or an excipient. Thereby, the storage stability of the emulsified preparation can be improved. Examples of the polyhydric alcohol that can be used in the invention include glycerol, diglycerol, triglycerol, polyglycerol, propylene glycol, dipropylene glycol, 1,3-butylene glycol, ethylene glycol, polyethylene glycol, sorbitol (D-sorbitol), xylitol, maltitol, erythritol, mannitol, xylose, glucose, lactose, mannose, oligotose, fructose-glucose syrup, and sucrose.

These polyhydric alcohols can be used each alone or two or more types thereof can be used in any combination.

In the invention, the polyhydric alcohol is preferably propylene glycol or glycerol, or a combination thereof.

The content of the polyhydric alcohol in the emulsified preparation of the invention is not particularly limited and can be appropriately adjusted according to the desired emulsified preparation. The content of the polyhydric alcohol with respect to the total amount of the paprika emulsified dye preparation is exemplified by, for example, 10 mass % or more, and is preferably 15 mass % or more, more preferably 20 mass % or more, and further more preferably 25 mass % or more. The upper limit of the content of the polyhydric alcohol is also not particularly limited, but is, for example, 60 mass % or less, preferably 58 mass % or less, more preferably 55 mass % or less, and further more preferably 50 mass % or less with respect to the total amount of the paprika emulsified dye preparation. Therefore, the content of the polyhydric alcohol with respect to the total amount of the paprika emulsified dye preparation is, for example, 10 to 60 mass %, preferably 15 to 58 mass %, more preferably 20 to 55 mass %, and further more preferably 25 to 50 mass % with respect to the total amount of the paprika emulsified dye preparation.

### Water

Examples of the water that can be used in the invention includes pure water, ion exchanged water, and tap water.

The content of the water is not limited, but can be set to, for example, 5 mass % or more, and is preferably 10 mass % or more, more preferably 15 mass % or more, further more preferably 20 mass % or more, and particularly preferably 25 mass % or more with respect to the total amount of the paprika emulsified dye preparation.

pH

The pH of the “aqueous phase” of the invention is appropriately adjusted according to the types of components blended and the contents thereof, the dosage form, or the like, and is not limited, but can be, for example, within a range of 2 to 8, a range of 2.5 to 7.5, or a range of 3 to 7. In addition, in order to adjust the pH of the “aqueous phase” within the above range, an organic acid and/or an inorganic acid can be used as needed. The type of organic acid and/or inorganic acid is not particularly limited.

Examples of the organic acid and/or the inorganic acid include citric acid, phytic acid, ascorbic acid, phosphoric acid, lactic acid, adipic acid, gluconic acid, succinic acid, acetic acid, tartaric acid, fumaric acid, malic acid, and pyrophosphoric acid. These organic acids and/or inorganic acids can be used each alone or two or more types thereof can be used in any combination.

A preferred organic acid and/or inorganic acid in the invention is one or more types selected from the group consisting of citric acid, phytic acid, ascorbic acid, phosphoric acid, and lactic acid.

### Inorganic Salt

Examples of the inorganic salt that can be used in the invention include common table salt (sodium chloride) and potassium chloride.

The content of the inorganic salt with respect to the total amount of the paprika emulsified dye preparation is not particularly limited and can be set to 1 mass % or more, and is preferably 3 mass % or more. The upper limit of the content of the inorganic salt is not particularly limited, but is, for example, 10 mass % or less, and preferably 8 mass % or less with respect to the total amount of the paprika emulsified dye preparation.

The “aqueous phase” of the invention may contain, as another optional component, a water-soluble vitamin, a thickening stabilizer such as dextrin, an antioxidant, a chelating agent, a preservative, a water-soluble flavor, a water-soluble oxidation inhibitor, or the like within the range where the effect of the invention is not impaired.

Examples of the water-soluble flavor that can be used in the invention include a water-soluble butter flavor and an alcohol-based flavor.

Examples of the water-soluble oxidation inhibitor that can be used in the invention include ascorbic acid or erythorbic acid, a derivative thereof, and a salt thereof.

The dosage form of the paprika emulsified dye preparation is not particularly limited, and examples thereof include a liquid form, a paste form, a powder form, a granular form, and a tablet form. Above all, it is preferably in a liquid form.

The color density per mass percent of the oil phase contained in the paprika emulsified dye preparation is preferably 1500 CV or more. For example, the lower limit of the color density per mass percent of the oil phase contained in the paprika emulsified dye preparation is 1800 CV or more, 1900 CV or more, 2000 CV or more, 2100 CV or more, 2200 CV or more, 2300 CV or more, 2400 CV or more, or 2500 CV or more, and the upper limit thereof is 3500 CV or less, 3000 CV or less, 2900 CV or less, or 2800 CV or less.

The color density (CV) per mass percent of the oil phase in the emulsified preparation of the invention can be calculated from the color density calculated from the color value shown below and the mass percent of the oil phase.

The color value (10% E) can be measured according to the color value measurement method described in Japan's Specifications and Standards for Food Additives. Specifically, an appropriate amount of the paprika emulsified dye preparation is weighed and primarily diluted with ion exchanged water, and the solution is further secondarily diluted with acetone. The color value (color value=(10×A×dilution ratio)/amount of sample collected (g)) can be calculated by measuring the absorbance (A) at the maximum absorption wavelength for the obtained diluted solution using acetone as a control. From the calculated color value, the color density (CV) can be calculated according to the calculation formula (color value 10% E×66=color density (CV)) specified by the MSD-10 method.

The amount of the oil phase contained in the paprika emulsified dye preparation can be measured by recovering the oil phase. Specifically, saturated saline solution and a 95% alcohol are added to the paprika emulsified dye preparation whose mass has been measured in advance, oil-water separation is performed by shaking, and the mass of the recovered oil phase is measured, whereby the mass percent of the oil phase contained in the paprika emulsified dye preparation can be calculated.

Accordingly, the color density per percent of the oil phase can be calculated according to the following formula.

Color density (CV) per mass percent of oil phase=Color density (CV) of paprika dye preparation/mass percent of oil phase in preparation

The volume-based median diameter (D50) of emulsified particles contained in the paprika emulsified dye preparation is 1 to 3 μm, and is for example, 1.1 to 3 μm, 1.2 to 3 μm, 1.3 to 3 μm, 1.4 to 3 μm, 1.5 to 3 μm, 1.6 to 3 μm, 1.7 to 3 μm, or 1.8 to 3 μm.

The volume-based median diameter (D50) of the emulsified particles contained in the paprika emulsified dye preparation can be measured from the particle size distribution. The particle size distribution is measured on a volume basis using a laser diffraction type particle size distribution meter. Specifically, the measurement can be performed according to the description of Examples described later.

### Color Tone of Paprika Emulsified Dye Preparation

The hue of the paprika emulsified dye preparation is preferably 25 to 34. More preferably, it is 25 to 30. In the present specification, the hue of the paprika emulsified dye preparation is obtained by diluting the paprika emulsified dye preparation with an aqueous solution in which milk is diluted to 50% with ion exchanged water (in the present specification, it is sometimes referred to as “50% milk water”) so that the color density of the paprika dye becomes 300 CV, and calculating the hue from an a value and a b value measured using a color difference meter (for example, a color difference meter for juice NDJ-300A). Specifically, it is measured according to the description of Examples described later.

The chroma of the paprika emulsified dye preparation is preferably 30 to 44. More preferably, it is 30 to 41. In the present specification, the chroma of the paprika emulsified dye preparation is obtained by diluting the paprika emulsified dye preparation with 50% milk water so that the color density of the paprika dye becomes 300 CV, and calculating the chroma from the a value and the b value measured using a color difference meter (for example, a color difference meter for juice NDJ-300A) . Specifically, it is measured according to the description of Examples described later.

While not wishing to be bound by theory, in the case where the components contained in the paprika emulsified dye preparation are similar, when the volume-based median diameter (D50) of the emulsified particles is larger than 3 μm, it is presumed that the chroma decreases due to a decrease in the number of emulsified particles. On the other hand, when the volume-based median diameter (D50) of the emulsified particles is less than 1 μm, the chroma increases due to an increase in the number of emulsified particles, but the color tone becomes yellow. Therefore, it is considered that when the particle diameter is intermediate therebetween, the balance between the chroma and the reddish color tone is good.

The a value of the paprika emulsified dye preparation is exemplified by 30 to 36.

The b value of the paprika emulsified dye preparation is exemplified by 15 to 23.

The paprika emulsified dye preparation of the invention can be used as a colorant exhibiting a red color. Since the paprika emulsified dye preparation of the invention has a color density per mass percent of the oil phase of 1500 CV or more, it can exhibit a red color even if the particle size is within a range as follows: D50 value=1 to 3 μm.

In a preferred embodiment, the paprika emulsified dye preparation of the invention preferably has excellent stability. The stability of the paprika emulsified dye preparation can be evaluated, for example, using a D50 change ratio for the change in the particle size distribution when the paprika emulsified dye preparation is stored at 60° C. The D50 change ratio can be calculated by dividing the median diameter D50 (μm) after storage at 60° C. for 7 days by the median diameter D50 (μm) immediately after preparation. Specifically, the D50 change ratio is exemplified by 0.8 to 3. Preferably, it is 0.85 to 2.

Since the paprika emulsified dye preparation has excellent stability, it is expected that the coloring property of the paprika emulsified dye preparation is maintained.

When examining the color tone of the paprika emulsified dye preparation of the invention, a visual sensory test may be performed using a color chart.

### Production Method

The method for producing a paprika emulsified dye preparation of the invention preferably includes the following steps:
a step of mixing a paprika dye and an oil-based solvent, thereby preparing an oil phase having a color density per mass percent of the oil phase of 1500 CV or more; and
a step of mixing the oil phase and an aqueous phase containing water and an emulsifier, thereby preparing emulsified particles having a volume-based median diameter (D50) of 1 to 3 μm.

In the step of preparing the oil phase in the method for producing a paprika emulsified dye preparation, in addition to the paprika dye and the oil-based solvent, an oil-soluble emulsifier, an oil-soluble oxidation inhibitor, an oil-soluble flavor, or the like specifically described above may be further mixed.

When the form of the paprika dye used in the method for producing a paprika emulsified dye preparation is a liquid form, the oil phase is prepared by mixing the paprika dye and the oil-based solvent.

The mixing of the paprika dye and the oil-based solvent is not particularly limited in terms of means, method, conditions, etc.

The means, method, conditions, etc. for the mixing of the aqueous phase and the oil phase are not particularly limited as long as emulsified particles having a volume-based median diameter (D50) of 1 to 3 μm can be prepared. For example, the mixing itself may be an emulsifying treatment or it may be accompanied by an emulsifying treatment. The emulsifying treatment is exemplified by an emulsifying treatment using an emulsifying machine such as a homogenizer (such as a high-pressure homogenizer, a homodisper, a homomixer, a polytron stirrer, a colloid mill, or a nanomizer). The conditions for the emulsifying treatment may be appropriately determined according to the type of emulsifying machine to be used, or the like. More specifically, the more times the emulsifying step is repeated, the smaller the emulsified particle diameter becomes. Therefore, the emulsifying step and the step of measuring the emulsified particle diameter are repeated to adjust the particle diameter to a desired diameter of 1 to 3 μm.

Further, when the paprika emulsified dye preparation contains another component in addition to the paprika dye, the oil-based solvent, water, and the emulsifier, the other component can be mixed at any stage of the production of the paprika emulsified dye preparation according to the type of the component, the intended use thereof, or the like.

In the step of preparing the oil phase, heating can be performed. In addition, the step of preparing the aqueous phase, heating can be performed.

The paprika dye preparation produced by the method of the invention may be optionally prepared in the form of a powder or the like. Regardless of which dosage form it is prepared in, it is first prepared in a liquid form by the above-mentioned steps, and then, a powdering step is further performed.

### Powdering Step

The dye preparation in a liquid form prepared by the above-mentioned steps can be powdered by adding an excipient such as dextrin thereto, and subjecting the resultant to a spray dryer.

When the powdered preparation is redissolved by adding an appropriate amount of water or the like, the original red color tone can be exhibited again.

The paprika emulsified dye preparation can be used for, for example, coloring a food or drink, a pharmaceutical product, a quasi-drug, a cosmetic product, or the like. Above all, it can be suitably used for coloring a food using a white base such as ice cream or crab sticks. The amount of the paprika emulsified dye preparation to be blended in a product to be colored is not particularly limited, and can be appropriately set according to the product form or the degree of coloration.

Specific examples of the food or drink include drinks such as milk drinks, lactic acid bacteria drinks, carbonated drinks, fruit drinks (such as fruit juice drinks, soft drinks containing fruit juice, carbonated drinks containing fruit juice, and fruit pulp drinks), vegetable drinks, vegetable and fruit drinks, alcoholic drinks such as liqueurs, coffee drinks, powdered drinks, sport drinks, and supplement drinks; tea drinks such as black tea drinks, green tea, and blended tea (drinks and tea drinks are encompassed in “drinks”); desserts such as puddings including custard puddings, milk puddings, puddings containing fruit juice, etc. jellies, Bavarian cream, and yogurt; cold desserts such as milk ice cream, ice cream and soft cream containing fruit juice, and ice candies; gum such as chewing gum and bubble gum (such as stick gum and sugar-coated pellet gum); chocolates such as coated chocolates (such as marble chocolates) and flavored chocolates (such as strawberry chocolate, blueberry chocolate, and melon chocolate); candies such as hard candies (such as bonbons, butterballs, and marbles), soft candies (such as caramel, nougat, gummy candies, and marshmallows), sugar-coated candies, drops, and taffy; soups such as consomme soup, potage, and soups; liquid seasonings such as separate dressing, non-oil dressing, ketchup, sauces, and Worcester sauce; jams such as strawberry jam, blueberry jam, marmalade, apple jam, apricot jam, preserves, and syrups; fruit wines such as red wine; fruits for processing such as syrup-pickled cherries, apricots, apples, strawberries, and peaches; agricultural processed products such as pickles; processed meat products such as hams and sausages; processed marine products such as fish sausages, Hanpen (a white, square, triangle, or round fish paste product), Chikuwa (a tubular fish paste product), Kamaboko (a semicylindrical fish paste product), and crab sticks; dairy products; flour (such as Okonomiyaki flour and Takoyaki flour); noodles; liquid foods; health foods; and supplements. Among them, preferably, drinks, desserts (particularly preferably jellies), candies, jams, pickles, liquid seasonings, and processed marine products are exemplified.

Examples of the pharmaceutical product and the quasi-drug include syrups, drinks, tablets, capsules, tinctures, creams, and ointments. Among these, preferably, drinks and syrups are exemplified.

Examples of the cosmetic product include toothpastes, shampoos, hair conditioners, body soaps, and cosmetic materials.

By adding the paprika emulsified dye preparation of the invention at any stage of the preparation of a product to be colored, the product colored red can be prepared. As described above, according to the invention, a product to be colored can be colored red.

Note that in the present specification, the term “comprising” includes “consisting essentially of” and “consisting of”. Further, the invention includes all arbitrary combinations of the configuration requirements described herein.

### EXAMPLES

The contents of the invention will be specifically described using the following Examples. However, the invention is by no means limited thereto. In the following description, the experiments were performed under atmospheric pressure and normal temperature conditions unless otherwise specified. In addition, unless otherwise specified, “%” means “mass %”.

### 1) Preparation of Paprika Emulsified Preparation Using Gum Arabic

After a 35% aqueous gum arabic solution was prepared using Gum Arabic SD (manufactured by San-Ei Gen F.F.I., Inc.), a paprika emulsified preparation was prepared according to the composition shown in the following Table 1. As a specific preparation method, after mixing the respective components of the oil phase, the mixture was heated to 90° C. and added to a 35% aqueous gum arabic solution in which common table salt was dissolved, followed by stirring at 3000 rpm for 3 minutes. Thereafter, a 50% lactic acid solution and glycerol were added thereto, and the mixture was stirred at 3000 rpm for 1 minute. Thereafter, the mixture was subjected to an emulsifying treatment (conditions: 500 kg/cm², 4 times) with a high-pressure homogenizer (homogenizer 15MR-8TA, manufactured by MANTON-GAULIN Company), whereby a paprika emulsified preparation using gum arabic was obtained. Note that “Blended amount of paprika dye (CV)” in Table 1 indicates the color density (CV value) of the paprika dye with respect to the total amount of the paprika emulsified dye preparation.

TABLE 1

| | Example | Example | Example | Example | Example | Example | Example |
|---|---|---|---|---|---|---|---|
| | 1 | 2 | 3 | 4 | 5 | 6 | 7 |
| Paprika dye | 13.3 | 15.0 | 16.7 | 16.7 | 16.7 | 16.7 | 16.7 |
| (color value: 4550) | | | | | | | |
| dl-α-tocopherol | 1.0 | 1.0 | 3.0 | 1.0 | | 1.0 | 1.0 |
| Medium-chain fatty | 1.7 | 2.0 | 0.3 | 2.3 | 3.3 | 1.5 | |
| acid triglyceride | | | | | | | |
| Corn oil | | | | | | | 2.3 |
| Acetylated sucrose | | | | | | | |
| fatty acid ester | | | | | | | |
| (HLB: 0) | | | | | | | |
| Flavor | | | | | | 0.8 | |
| Total oil phase | 16 | 18 | 20 | 20 | 20 | 20 | 20 |
| 35% aqueous gum | 48.0 | 47.0 | 45.5 | 45.5 | 45.5 | 45.5 | 45.5 |
| arabic solution | | | | | | | |
| Common table salt | 4.0 | 4.0 | 4.0 | 4.0 | 4.0 | 4.0 | 4.0 |
| 50% lactic acid | 0.5 | 0.5 | 0.5 | 0.5 | 0.5 | 0.5 | 0.5 |
| solution | | | | | | | |
| Glycerol | 31.5 | 30.0 | 30.0 | 30.0 | 30.0 | 30.0 | 30.0 |
| Total | 84 | 82 | 80 | 80 | 80 | 80 | 80 |
| aqueous phase | | | | | | | |
| Total | 100 | 100 | 100 | 100 | 100 | 100 | 100 |
| Glycerol ratio | 50.4 | 50.1 | 50.5 | 50.5 | 50.5 | 50.5 | 50.5 |
| Particle size | 1.69 | 1.98 | 2.74 | 2.24 | 2.64 | 2.23 | 2.54 |
| distribution | | | | | | | |
| D50 (μm) | | | | | | | |
| Blended amount of | 40000 | 45000 | 50000 | 50000 | 50000 | 50000 | 50000 |
| paprika dye (CV) | | | | | | | |
| CV per percent of | 2500 | 2500 | 2500 | 2500 | 2500 | 2500 | 2500 |
| oil phase | | | | | | | |
| | Example | Example | Example | Example | Example | Example | Example |
| | 8 | 9 | 10 | 11 | 12 | 13 | 14 |
| Paprika dye | 16.7 | 16.7 | 16.7 | 16.7 | 16.7 | 15.0 | 15.0 |
| (color value: 4550) | | | | | | | |
| dl-α-tocopherol | 1.0 | 1.0 | 1.0 | 1.0 | 1.0 | 0.9 | 0.9 |
| Medium-chain fatty | | 0.3 | 1.3 | 1.8 | 2.2 | 0.3 | 1.2 |
| acid triglyceride | | | | | | | |
| Corn oil | 2.2 | | | | | | |
| Acetylated sucrose | 0.1 | 2.0 | 1.0 | 0.5 | 0.1 | 1.8 | 0.9 |
| fatty acid ester | | | | | | | |
| (HLB: 0) | | | | | | | |
| Flavor | | | | | | | |
| Total oil phase | 20 | 20 | 20 | 20 | 20 | 18 | 18 |
| 35% aqueous gum | 45.5 | 45.5 | 45.5 | 45.5 | 45.5 | 47.0 | 47.0 |
| arabic solution | | | | | | | |
| Common table salt | 4.0 | 4.0 | 4.0 | 4.0 | 4.0 | 4.0 | 4.0 |
| 50% lactic acid | 0.5 | 0.5 | 0.5 | 0.5 | 0.5 | 0.5 | 0.5 |
| solution | | | | | | | |
| Glycerol | 30.0 | 30.0 | 30.0 | 30.0 | 30.0 | 30.5 | 30.5 |
| Total | 80 | 80 | 80 | 80 | 80 | 82 | 82 |
| aqueous phase | | | | | | | |
| Total | 100 | 100 | 100 | 100 | 100 | 100 | 100 |
| Glycerol ratio | 50.5 | 50.5 | 50.5 | 50.5 | 50.5 | 50.1 | 50.1 |
| Particle size | 2.38 | 2.51 | 2.53 | 2.53 | 2.40 | 2.23 | 2.23 |
| distribution | | | | | | | |
| D50 (μm) | | | | | | | |
| Blended amount of | 50000 | 50000 | 50000 | 50000 | 50000 | 45000 | 45000 |
| paprika dye (CV) | | | | | | | |
| CV per percent of | 2500 | 2500 | 2500 | 2500 | 2500 | 2500 | 2500 |
| oil phase | | | | | | | |

| | Example | Example | Example | Example | Example | Example | Example |
|---|---|---|---|---|---|---|---|
| | 15 | 16 | 17 | 18 | 19 | 20 | 21 |
| Paprika dye | 15.0 | 10.0 | 11.7 | 13.3 | 13.3 | 13.3 | 13.3 |
| (color value: 4550) | 0.9 | 0.6 | 0.7 | 0.8 | 0.8 | 0.8 | 0.8 |
| dl-α-tocopherol | | | | | | | |
| Medium-chain fatty | 1.7 | 1.1 | 1.3 | 0.3 | 1.5 | 1.0 | 1.4 |
| acid triglyceride | | | | | | | |
| Corn oil | | | | | | | |
| Acetylated sucrose | 0.5 | 0.3 | 0.4 | 1.6 | 0.4 | 0.4 | 0.4 |
| fatty acid ester | | | | | | | |
| (HLB: 0) | | | | | | | |
| Flavor | | | | | | 0.5 | 0.1 |
| Total oil phase | 18 | 12 | 14 | 16 | 16 | 16 | 16 |
| 35% aqueous gum | 47.0 | 50.5 | 49.5 | 48.0 | 48.0 | 48.0 | 48.0 |
| arabic solution | | | | | | | |
| Common table salt | 4.0 | 4.0 | 4.0 | 4.0 | 4.0 | 4.0 | 4.0 |
| 50% lactic acid | 0.5 | 0.5 | 0.5 | 0.5 | 0.5 | 0.5 | 0.5 |
| solution | | | | | | | |
| Glycerol | 30.5 | 33.0 | 32.0 | 31.5 | 31.5 | 31.5 | 31.5 |
| Total aqueous | 82 | 88 | 86 | 84 | 84 | 84 | 84 |
| phase | | | | | | | |
| Total | 100 | 100 | 100 | 100 | 100 | 100 | 100 |
| Glycerol ratio | 50.1 | 50.3 | 50.1 | 50.4 | 50.4 | 50.4 | 50.4 |
| Particle size | 1.78 | 2.01 | 2.13 | 2.00 | 1.86 | 1.87 | 1.85 |
| distribution | | | | | | | |
| D50 (μm) | | | | | | | |
| Blended amount of | 45000 | 30000 | 3500 | 40000 | 40000 | 40000 | 40000 |
| paprika dye (CV) | | | | | | | |
| CV per percent of oil phase | 2500 | 2500 | 2500 | 2500 | 2500 | 2500 | 2500 |

| | Example | Example | Example | Example | Comparative | Comparative |
|---|---|---|---|---|---|---|
| | 22 | 23 | 24 | 25 | Example 1 | Example 2 |
| Paprika dye | 13.3 | 11.7 | 10.0 | 8.3 | 6.7 | 5.0 |
| (color value: 4550) | 0.8 | 0.8 | 0.8 | 0.8 | 0.8 | 0.8 |
| dl-α-tocopherol | | | | | | |
| Medium-chain fatty | 1.5 | 3.1 | 4.8 | 6.5 | 8.1 | 9.8 |
| acid triglyceride | | | | | | |
| Corn oil | | | | | | |
| Acetylated sucrose | 0.4 | 0.4 | 0.4 | 0.4 | 0.4 | 0.4 |
| fatty acid ester | | | | | | |
| (HLB: 0) | | | | | | |
| Flavor | 0.0 | | | | | |
| Total oil phase | 16 | 16 | 16 | 16 | 16 | 16 |
| 35% aqueous gum | 48.0 | 48.0 | 48.0 | 48.0 | 48.0 | 48.0 |
| arabic solution | | | | | | |
| Common table salt | 4.0 | 4.0 | 4.0 | 4.0 | 4.0 | 4.0 |
| 50% lactic acid | 0.5 | 0.5 | 0.5 | 0.5 | 0.5 | 0.5 |
| solution | | | | | | |
| Glycerol | 31.5 | 31.5 | 31.5 | 31.5 | 31.5 | 31.5 |
| Total aqueous | 84 | 84 | 84 | 84 | 84 | 84 |
| phase | | | | | | |
| Total | 100 | 100 | 100 | 100 | 100 | 100 |
| Glycerol ratio | 50.4 | 50.4 | 50.4 | 50.4 | 50.4 | 50.4 |
| Particle size | 1.76 | 1.93 | 1.78 | 1.77 | 1.68 | 1.21 |
| distribution | | | | | | |
| D50 (μm) | | | | | | |
| Blended amount of | 40000 | 35000 | 30000 | 25000 | 20000 | 15000 |
| paprika dye (CV) | | | | | | |
| CV per percent of oil phase | 2500 | 2188 | 1875 | 1563 | 1250 | 938 |

Flavor: MASKING OIL VM-217 (San-Ei Gen F.F.I., Inc. )

### 2) Preparation of Paprika Emulsified Preparation Using Sucrose Fatty Acid Ester

A paprika emulsified preparation using a sucrose fatty acid ester was prepared according to the composition shown in the following Table 2. As a specific preparation method, first, the respective components of the aqueous phase in Table 2 were mixed at 60° C. for 10 minutes, and after confirming that there was no undissolved residue, the mixture was cooled to 40° C. Subsequently, the respective components of the oil phase were mixed, and the mixture was heated to 100° C. and mixed with the aqueous phase, followed by stirring at 3000 rpm for 3 minutes, whereby a paprika emulsified preparation using a sucrose fatty acid ester was obtained.

TABLE 2

| | Example | Example | Comparative |
|---|---|---|---|
| | 26 | 27 | Example 3 |
| Paprika dye (color value: 4550) | 16.7 | 16.7 | 16.7 |
| dl-α-tocopherol | 1.0 | 1.0 | 1.0 |
| Medium-chain fatty acid triglyceride | 2.8 | 2.8 | 2.3 |
| Total oil phase | 20.5 | 20.5 | 20 |
| Sucrose fatty acid ester (HLB: 15) | 0.5 | 0.8 | 2.0 |
| Sunflower-derived lecithin | 2.0 | 2.0 | 2.0 |
| Glycerol | 42.5 | 42.3 | 42.0 |
| Ion exchanged water | 34.5 | 34.5 | 34.0 |
| Total aqueous phase | 80 | 80 | 80 |
| Total | 100 | 100 | 100 |
| Glycerol ratio | 55.2 | 55.0 | 55.3 |
| Particle size distribution D50 (μm) | 2.64 | 2.47 | 0.68 |
| Blended amount of paprika dye (CV) | 50000 | 50000 | 50000 |
| CV per percent of oil phase | 2439 | 2439 | 2500 |

### 3) Measurement of Particle Size Distribution of Paprika Emulsified Dye Preparation

The volume-based median diameter (unit: μm) of each of the paprika preparations prepared in the above 1) and 2) was measured with a laser diffraction type particle size distribution meter Microtrac MT-3000 II (manufactured by MicrotracBEL Corp.) (refractive index: 1.81, measurement range: 0.021 to 2000 μm, particle size distribution: volume basis). In the following, the particle size of the emulsified particles was measured using the method.

It was confirmed that Examples 1 to 27 in Tables 1 and 2 all macroscopically exhibit a red color. On the other hand, it was confirmed that Comparative Examples 1 and 2 in which the color density per mass percent of the oil phase is less than 1500 CV, and Comparative Example 3 in which the volume-based median diameter (D50) of the emulsified particles is less than 1 μm macroscopically exhibit an orange color. From the results, it was confirmed that a paprika emulsified dye preparation having characteristics that the color density per mass percent of the oil phase is 1500 CV or more and the volume-based median diameter (D50) of the emulsified particles is 1 to 3 μm exhibits a red color.

The paprika emulsified dye preparations prepared in 1) and 2) were stored at 60° C. for 3 days or 7 days, and then, the median diameter was measured by the same method (Tables 3 and 4).

TABLE 3

| | Immediately | | | D50 change ratio |
|---|---|---|---|---|
| | after | 60° C. | | (after storage for |
| | preparation | 3 days | 7 days | 7 days/immediately |
| | D50 (μm) | D50 (μm) | D50 (μm) | after preparation) |
| Example 1 | 1.69 | 2.83 | 3.04 | 1.8 |
| Example 2 | 1.98 | 3.55 | 3.90 | 2.0 |
| Example 4 | 2.24 | 4.92 | 5.94 | 2.7 |
| Example 5 | 2.64 | 5.42 | 8.61 | 3.3 |
| Example 7 | 2.54 | 4.03 | 5.28 | 2.1 |
| Example 8 | 2.38 | 3.77 | 4.52 | 1.9 |
| Example 9 | 2.51 | 59.98 | 20.98 | 8.4 |
| Example 10 | 2.53 | 5.18 | 7.32 | 2.9 |
| Example 11 | 2.53 | 3.56 | 4.39 | 1.7 |
| Example 12 | 2.40 | 3.90 | 5.26 | 2.2 |
| Example 13 | 2.23 | 46.26 | 60.30 | 27.1 |
| Example 14 | 2.23 | 4.92 | 6.82 | 3.1 |
| Example 15 | 1.78 | 2.89 | 3.58 | 2.0 |
| Example 16 | 2.01 | 1.87 | 1.78 | 0.9 |
| Example 17 | 2.13 | 2.01 | 1.97 | 0.9 |
| Example 18 | 2.00 | 9.00 | 9.35 | 4.7 |
| Example 19 | 1.86 | 2.03 | 2.17 | 1.2 |
| Example 20 | 1.87 | 2.33 | 2.81 | 1.5 |
| Example 21 | 1.85 | 2.32 | 2.56 | 1.4 |
| Example 22 | 1.76 | 2.06 | 2.32 | 1.3 |

TABLE 4

| | Immediately | | | D50 change ratio |
|---|---|---|---|---|
| | after | 60° C. | | (after storage for |
| | preparation | 4 days | 7 days | 7 days/immediately |
| | D50 (μm) | D50 (μm) | D50 (μm) | after preparation) |
| Example 26 | 2.64 | 2.96 | 4.46 | 1.7 |
| Example 27 | 2.47 | 2.07 | 2.41 | 1.0 |
| Comparative | 0.68 | 0.67 | 0.67 | 1.0 |
| Example 3 | | | | |

In Examples 1, 2, 4, 7, 8, 10 to 12, 15 to 17, 19 to 22, 26, and 27, not only the paprika emulsified dye preparation exhibits a red color, but also the D50 change ratio (after storage at 60° C. for 7 days/immediately after preparation) is 3.0 or less, and it was confirmed that the emulsified particles are stable. Among them, in Examples 1, 2, 8, 11, 15, 16, 17, 19 to 22, 26, and 27, the D50 change ratio (after storage for 7 days/immediately after preparation) is 2.0 or less, and it was confirmed that the emulsified particles are particularly stable.

### 4) Color Evaluation Test for Preparation

The paprika emulsified dye preparations (Examples 23 to 27 and Comparative Examples 1 to 3) prepared in the above 1) and 2), and paprika emulsified dye preparations which were prepared by following the formulation of Example 19 and variously changing the emulsifying conditions (Examples 28 to 36; prepared by using a homogenizer 15MR-8TA and combining a pressure of 250 kg/cm² to 500 kg/cm² at the time of emulsification and 2 to 8 emulsification times) were diluted with 50% milk water so that the color density of the paprika dye becomes 300 CV, and the Lab values were measured under the following conditions using a color difference meter for juice NDJ-300A (manufactured by Nippon Denshoku Industries Co. Ltd.) (Table 5).
Color measurement: reflection color measurement
Hue: tan⁻¹ (b/a)
Chroma: \sqrt{ } (a²+b²)

The color of each of the dye preparations of Examples 23 to 36 were visually observed. In addition, the intensity (darkness) of red color was compared with one another, and the respective preparations were arranged in order from the weakest to the strongest redness.

TABLE 5

| | | | | | | | Macroscopic observation | | | |
|---|---|---|---|---|---|---|---|---|---|---|
| | D50 | | | | | | | red | | |
| | (μm) | L | a | b | hue | chroma | orange | weak | medium | strong |
| Example 23 | 1.93 | 44.45 | 34.87 | 19.31 | 28.98 | 39.86 | | | ∘ | |
| Example 24 | 1.78 | 44.38 | 35.57 | 20.49 | 29.94 | 41.05 | | ∘ | | |
| Example 25 | 1.77 | 44.92 | 35.83 | 22.69 | 32.34 | 42.41 | | ∘ | | |
| Example 26 | 2.64 | 38.23 | 33.86 | 16.86 | 26.47 | 37.83 | | | ∘ | |
| Example 27 | 2.47 | 37.88 | 34.86 | 17.81 | 27.06 | 39.15 | | ∘ | | |
| Example 28 | 2.84 | 38.65 | 31.49 | 16.61 | 27.81 | 35.60 | | | | ∘ |
| Example 29 | 2.60 | 37.93 | 33.54 | 16.90 | 26.74 | 37.56 | | | | ∘ |
| Example 30 | 1.94 | 37.56 | 34.57 | 17.35 | 26.65 | 38.68 | | | ∘ | |
| Example 31 | 1.73 | 37.27 | 34.97 | 17.22 | 26.22 | 38.98 | | | ∘ | |
| Example 32 | 1.61 | 37.34 | 35.34 | 17.61 | 26.49 | 39.48 | | | ∘ | |
| Example 33 | 1.53 | 37.33 | 35.14 | 17.25 | 26.15 | 39.15 | | | ∘ | |
| Example 34 | 1.50 | 37.32 | 35.51 | 17.54 | 26.29 | 39.61 | | | ∘ | |
| Example 35 | 1.44 | 37.19 | 35.51 | 17.60 | 26.36 | 39.63 | | | ∘ | |
| Example 36 | 1.86 | 46.60 | 30.61 | 15.02 | 26.14 | 34.10 | | | | ∘ |
| Comparative | 1.68 | 44.92 | 36.60 | 25.40 | 34.76 | 44.55 | ∘ | | | |
| Example 1 | | | | | | | | | | |
| Comparative | 1.21 | 45.43 | 36.77 | 27.90 | 37.19 | 46.16 | ∘ | | | |
| Example 2 | | | | | | | | | | |
| Comparative | 0.68 | 37.72 | 37.46 | 22.51 | 31.00 | 43.70 | ∘ | | | |
| Example 3 | | | | | | | | | | |

It was confirmed that in Examples 23 to 36, a red color is exhibited, and also the color tone is bright. In addition, as shown in Table 5, the respective preparations could be classified into three according to the intensity of redness. Among them, it was confirmed that in Examples 28, 29, and 36, the redness is particularly strong, and also the color tone is bright.

Further, as is clear from this experiment, it was revealed that as long as the embodiment of the invention is adopted, a paprika emulsified dye preparation can be adjusted to a desired color tone by changing the emulsifying conditions to adjust the median diameter even with the same formulation as in Example 19 (Examples 28 to 36) .

### 5) Food Coloring Test

### Coloring Test for Milk Water

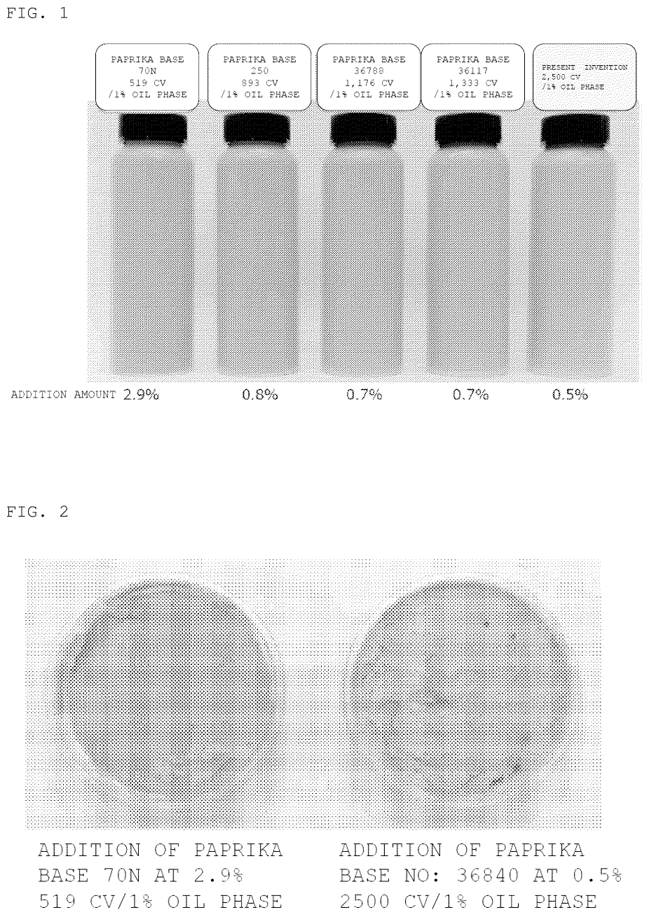

Conventional paprika emulsified dye preparations (Paprika base 70N: 519 CV/1% oil phase, paprika base 250: 893 CV/1% oil phase, paprika base 36788: 1,176 CV/1% oil phase, and paprika base 36117: 1,333 CV/1% oil phase) and the paprika dye preparation of Example 19 (2,500 CV/1% oil phase) were used to color milk so that the color density was 200 CV (FIG. 1).

The milk colored with the preparation of Example 19 exhibited a red color tone. On the other hand, the conventional paprika emulsified dye preparations having a color density per percent of the oil phase less than 1500 CV did not produce a red color tone. From this, it was revealed that in order to produce the red paprika preparation of the invention, it is necessary to set the color density per percent of the oil phase to 1500 CV or more.

### Coloring Test for Ice Cream

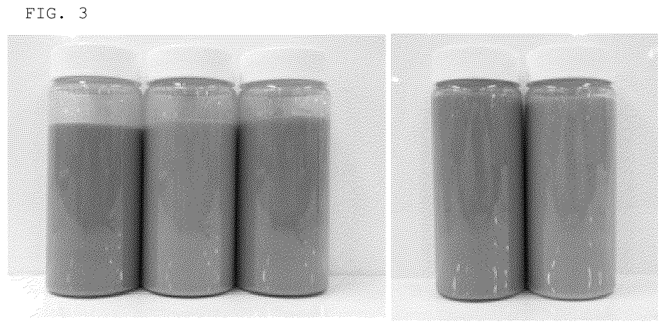

A conventional paprika dye preparation (Paprika base 70N: 519 CV/1% oil phase) and the paprika dye preparation of Example 19 (2,500 CV/1% oil phase) were used to color ice cream so that the color density was 200 CV (FIG. 2).

In the same manner as the coloring test for milk, the dye preparation having a color density per percent of the oil phase less than 1500 CV did not produce a red color tone, and the color tone remained orange (FIG. 2). On the other hand, when the preparation of Example 19 having a color density per percent of the oil phase of 1500 CV or more was used, the ice cream could be colored to have a red color tone (FIG. 2).

### 6) Preparation of Paprika Emulsified Dye Preparation Using Various Oil Types

A 35% aqueous gum arabic solution was prepared according to the composition shown in the following Table 6 and sterilized while stirring (in a hot water bath at 93° C. for 1 hour).

TABLE 6

| Arabic powder HP | |
|---|---|
| LOT: 191224 | 35.0 |
| Citric acid (anhydride) F4020 | 0.2 |
| 50% lactic acid solution | 0.8 |
| Ion exchanged water | 64 |
| Total | 100 |

A paprika emulsified dye preparation was prepared according to the composition shown in the following Table 7. Specifically, after mixing the respective components of the oil phase, the mixture was heated to 90° C. and added to a 35% aqueous gum arabic solution in which common table salt was dissolved, followed by stirring at 3000 rpm for 3 minutes. Thereafter, a 50% lactic acid solution and glycerol were added thereto, and the mixture was stirred at 3000 rpm for 1 minute. Thereafter, the mixture was subjected to an emulsifying treatment (conditions: 50 MPa, twice) (Table 7, Examples 37 to 39).

TABLE 7

| | Example | Example | Example |
|---|---|---|---|
| | 37 | 38 | 39 |
| Paprika dye (color value: 4550) | 13.08 | 13.08 | 13.08 |
| dl-α-tocopherol | 0.8 | 0.8 | 0.8 |
| Rice salad oil | 1.72 | — | — |
| Safflower oil | — | 1.72 | — |
| Soybean white squeezed oil | — | — | 1.72 |
| Acetylated sucrose fatty acid ester (HLB: 0) | 0.4 | 0.4 | 0.4 |
| Total oil phase | /16.00 | /16.00 | /16.00 |
| 35% aqueous gum arabic solution | 48.0 | 48.0 | 48.0 |
| Common table salt | 4.0 | 4.0 | 4.0 |
| 50% lactic acid solution | 0.5 | 0.5 | 0.5 |
| Glycerol | 31.5 | 31.5 | 31.5 |
| Total aqueous phase | /84.00 | /84.00 | /84.00 |
| Total | 100.0 | 100.0 | 100.0 |
| Glycerol ratio | 50.4 | 50.4 | 50.4 |
| Particle size distribution D50 (μm) | 1.87 | 2.09 | 1.89 |
| Blended amount of paprika dye (CV) | 40000 | 40000 | 40000 |
| CV per percent of oil phase | 2,500 | 2,500 | 2,500 |

Even when rice salad oil (rice oil), safflower oil, or soybean white squeezed oil (soybean oil) was used as the oil-based solvent, a paprika emulsified dye preparation in which the volume-based median diameter (D50) of the emulsified particles is 1 to 3 μm could be prepared, and Examples 37 to 39 all macroscopically exhibited a red color.

### 7) Preparation of Paprika Emulsified Dye Preparation Using Sucrose Fatty Acid Ester or Polyglycerol Fatty Acid Ester

A paprika emulsified dye preparation was prepared using a sucrose fatty acid ester or a polyglycerol fatty acid ester as the emulsifier (Table 8, Examples 40 to 42). Specifically, first, a sucrose fatty acid ester or a polyglycerol fatty acid ester, and lecithin and glycerol were mixed at 60° C. for 10 minutes, and after confirming that there was no undissolved residue, the mixture was cooled to 50 to 55° C. A mixed liquid obtained by mixing the respective components of the oil phase and heating to 90° C. was added thereto, and the mixture was stirred at 3000 rpm for 3 minutes, then, ion exchanged water was further added thereto, and the mixture was stirred at 3000 rpm for 1 minute.

TABLE 8

| | Example | Example | Example |
|---|---|---|---|
| | 40 | 41 | 42 |
| Paprika dye (color value: 4550) | 16.35 | 16.35 | 16.35 |
| dl-α-tocopherol | 1.00 | 1.00 | 1.00 |
| Sunflower-derived lecithin | 1.50 | 1.50 | 1.50 |
| Medium-chain fatty acid triglyceride | 3.15 | 3.15 | 3.15 |
| Total oil phase | /22.00 | /22.00 | /22.00 |
| Sucrose fatty acid ester (HLB: 13) | 0.50 | — | — |
| Sucrose fatty acid ester (HLB: 11) | — | 0.50 | — |
| Polyglyceryl monooleate (HLB: 15) | — | — | 0.50 |
| Sunflower-derived lecithin | 0.50 | 0.50 | 0.50 |
| Glycerol | 42.50 | 42.50 | 42.50 |
| Ion exchanged water | 34.50 | 34.50 | 34.50 |
| Total aqueous phase | /78.00 | /78.00 | /78.00 |
| Total | 100.00 | 100.00 | 100.00 |
| Glycerol ratio | 55.2 | 55.2 | 55.2 |
| Particle size distribution D50 (μm) | 2.42 | 2.14 | 1.21 |
| Blended amount of paprika dye (CV) | 50000 | 50000 | 50000 |
| CV per percent of oil phase | 2,273 | 2,273 | 2,273 |

Even when a sucrose fatty acid ester having an HLB of 11 or 13 was used as the emulsifier, a paprika emulsified dye preparation in which the volume-based median diameter (D50) of the emulsified particles is 1 to 3 μm could be prepared. Further, even when a polyglycerol fatty acid ester was used, a paprika emulsified dye preparation in which the volume-based median diameter (D50) of the emulsified particles is 1 to 3 μm could be prepared. Further, Examples 40 to 42 all macroscopically exhibited a red color.

### 8) Preparation of Paprika Emulsified Dye Preparation Using Starch Octenyl Succinate

A paprika emulsified dye preparation was prepared using starch octenyl succinate as the emulsifier (Table 9, Examples 43 and 44). Specifically, after mixing the respective components of the oil phase, the mixture was heated to 90° C. and added to a mixed liquid of a 35% aqueous starch octenyl succinate solution, glycerol, and ion exchanged water, followed by stirring at 3000 rpm for 3 minutes. Thereafter, a 50% lactic acid solution and glycerol were added thereto, and the mixture was stirred at 3000 rpm for 1 minute.

TABLE 9

| | Example | Example |
|---|---|---|
| | 43 | 44 |
| Paprika dye (color value: 4550) | 14.71 | 16.35 |
| dl-α-tocopherol | 0.8 | 0.8 |
| Medium-chain fatty acid triglyceride | 2.09 | 2.45 |
| Acetylated sucrose fatty acid ester (HLB: 0) | 0.4 | 0.4 |
| Total oil phase | /18.00 | /20.00 |
| 35% aqueous starch octenyl succinate* solution | 48.0 | 48.0 |
| Glycerol | 3.0 | — |
| Ion exchanged water | 1.0 | 4 |
| 50% lactic acid solution | 0.5 | 0.5 |
| Glycerol | 29.5 | 27.5 |
| Total aqueous phase | /82.00 | /80.00 |
| | 100.0 | 100.0 |
| | 50.0 | 50.0 |
| Particle size distribution D50 (μm) | 1.05 | 1.08 |
| Blended amount of paprika dye (CV) | 45000 | 50000 |
| CV per percent of oil phase | 2,500 | 2,500 |

*PURITY GUM BE (manufactured by Ingredion Japan K. K.)

Even when starch octenyl succinate was used as the emulsifier, a paprika emulsified dye preparation in which the volume-based median diameter (D50) of the emulsified particles is 1 to 3 μm could be prepared. Further, Examples 43 to 44 all macroscopically exhibited a red color.

### 9) Preparation of Paprika Emulsified Dye Preparation Using Gum Ghatti

A paprika emulsified dye preparation was prepared using gum ghatti as the emulsifier (Table 10, Example 45). Specifically, after mixing the respective components of the oil phase, the mixture was heated to 90° C. and added to a mixed liquid containing a 20% aqueous gum ghatti solution, common table salt, saponin, glycerol, and ion exchanged water, followed by stirring at 3000 rpm for 3 minutes. Thereafter, a 50% lactic acid solution and glycerol were added thereto, and the mixture was stirred at 3000 rpm for 1 minute. Thereafter, the mixture was subjected to an emulsifying treatment (conditions: 50 MPa, twice).

The D50 of Example 45 was 2.02 μm, and a red color was macroscopically exhibited.

TABLE 10

| | Example 45 |
|---|---|
| Paprika dye (color value: 4550) | 16.35 |
| dl-α-tocopherol | 1 |
| Medium-chain fatty acid triglyceride | 2.65 |
| Total oil phase | /20.00 |
| 20% aqueous gum ghatti* solution | 10.0 |
| Common table salt | 4.0 |
| Saponin | 1.0 |
| Glycerol | 5.0 |
| Ion exchanged water | 28.0 |
| 50% lactic acid solution | 0.5 |
| Glycerol | 31.5 |
| Total aqueous phase | /80.00 |
| | 100.0 |
| | 50.2 |
| Particle size distribution D50 (μm) | 2.02 |
| Blended amount of paprika dye (CV) | 50000 |
| CV per percent of oil phase | 2,500 |

*Gum Ghatti SD (manufactured by San-Ei Gen F.F.I., Inc.) and 0.5% citric acid (anhydride)

### 10) Comparative Test 1

A paprika dye preparation was prepared according to the description of PTL 1 (JP2001-252043A) (Table 11, Comparative Examples 4 and 5). Specifically, Ryoto Polyglyester O-7D was added to glycerol and dissolved therein at 60° C., and the mixture was maintained at about 50° C. A paprika dye (100,000 CV) and SAIB were mixed, and the mixture was heated to 80° C. and poured into the mixed liquid of glycerol and Ryoto Polyglyester under stirring. While appropriately checking the particle diameter, stirring was performed so that the average particle diameter (D50) was about 5 μm (3000 rpm, 1 minute), whereby a paprika dye preparation was prepared.

Due to the low CV value per percent of the oil phase, Comparative Examples 4 and 5 both exhibited an orange color tone.

TABLE 11

| | Comparative | Comparative |
|---|---|---|
| | Example 4 | Example 5 |
| Paprika dye (100,000 CV) | 7.7 | 7.7 |
| SAIB | 7.7 | 7.7 |
| Total oil phase | 15.4 | 15.4 |
| Ryoto Polyglyester O-7D | 7.7 | 0.77 |
| (polyglycerol fatty acid ester) | | |
| Ion exchanged water | — | 6.93 |
| Glycerol | 76.9 | 76.9 |
| Total | 100.0 | 100.0 |
| Particle size distribution D50 (μm) | 1.13 | 5.12 |
| CV per percent of oil phase | 500 | 500 |

### 11) Comparative Test 2

A paprika dye preparation was prepared according to the description of PTL 2 (JPH05-316995A) (Table 12, Comparative Examples 6 to 9). Specifically, Arabic powder HP was added to ion exchanged water so as to have a solid content of 30% and dissolved therein at a temperature reaching 90° C., followed by cooling to about 45° C. Propylene glycol was added thereto to prepare an aqueous phase portion. A paprika dye (100,000 CV) and FR resin or O.D.O (medium-chain fatty acid triglyceride) were mixed, and the mixture was heated to 90° C. and added to the aqueous phase portion under stirring. While appropriately checking the particle diameter, stirring was performed so that the average particle diameter (D50) was about 10 μm, whereby a paprika dye preparation was prepared.

Due to the low CV value per percent of the oil phase, Comparative Examples 6 to 9 all exhibited an orange color tone.

TABLE 12

| | Compar- | Compar- | Compar- | Compar- |
|---|---|---|---|---|
| | ative | ative | ative | ative |
| | Example | Example | Example | Example |
| | 6 | 7 | 8 | 9 |
| Paprika dye | 10 | 10 | 10 | 10 |
| (100,000 CV) | | | | |
| FR resin | 10 | 5 | 5 | 5 |
| O. D.O | — | 5 | 5 | 5 |
| (medium-chain fatty | | | | |
| acidtriglyceride) | | | | |
| Total oil phase | 20 | 20 | 20 | 20 |
| 30% aqueous Arabic | 70 | 70 | 70 | 70 |
| powder HP solution | | | | |
| Propylene glycol | 10 | 10 | 10 | 10 |
| Total | 100 | 100 | 100 | 100 |
| Stirring speed (rpm) | 3000 | 3000 | 2000 | 300 |
| Stirring time (min) | 1 | 1 | 1 | 1 |
| D50 (μm) | — | 4.15 | 3.53 | 9.62 |
| CV per percent of | 500 | 500 | 500 | 500 |
| oil phase | | | | |

### 12) Comparative Test 3

A paprika dye preparation was prepared according to the description of PTL 3 (JP2006-109792A) (Table 13, Comparative Example 10). Specifically, gum arabic was added to ion exchanged water and dissolved therein at 60° C. A paprika dye (160,000 CV) and Poem S-60V were mixed, and the mixture was heated to 60° C. and poured into the aqueous gum arabic solution under stirring. While appropriately checking the particle diameter, stirring was performed so that the average particle diameter (D50) was about 1 to 3 μm, whereby a paprika dye preparation was prepared.

The dye preparation of Comparative Example 10 had a CV value per percent of the oil phase of 1412 and exhibited an orange color due to the fact that the CV value was lower than that of the invention.

TABLE 13

| | Comparative |
|---|---|
| | Example 10 |
| Paprika dye (160,000 CV) | 15 |
| Poem S-60V (sorbitan monostearate) | 2 |
| Total oil phase | 17 |
| Arabic powder HP | 30 |
| Ion exchanged water | 53 |
| Total | 100.0 |
| Particle size distribution D50 (μm) | 2.54 |
| CV per percent of oil phase | 1412 |

### 13) Comparative Test 4

In order to study the effect of the particle size of the emulsified particles, a paprika emulsified preparation satisfying the following condition: D50>3 μm was prepared (Table 14, Comparative Example 11). Specifically, after mixing the respective components of the oil phase, the mixture was heated to 90° C. and added to a 35% aqueous gum arabic solution (Table 6), followed by stirring at 3000 rpm for 3 minutes. Thereafter, a 50% lactic acid solution and glycerol were added thereto, and the mixture was stirred at 3000 rpm for 10 minutes.

The dye preparation of Comparative Example 11 had a D50 of 4.62 μm and exhibited a dark red color with low chroma due to the fact that the diameter of the emulsified particles was larger than that of the invention.

TABLE 14

| | | Comparative |
|---|---|---|
| | | Example 11 |
| Paprika dye (color value: 4550) | | 13.33 |
| dl-α-tocopherol | | 0.8 |
| Medium-chain fatty acid triglyceride | | 1.47 |
| Acetylated sucrose fatty acid ester (HLB: 0) | | 0.4 |
| | Total oil phase | /16.00 |
| 35% aqueous gum arabic solution | | 48 |
| Common table salt | | 4 |
| 50% lactic acid solution | | 0.5 |
| Glycerol | | 31.5 |
| | Total aqueous phase | /84.00 |
| | | /100.00 |
| | | 50.4 |
| Particle size distribution | D50 (μm) | 4.62 |
| | Blended amount of | 40000 |
| | paprika dye (CV) | |
| | CV per percent of oil phase | 2,500 |

The color evaluation was performed for various preparations by the method described in the above 4) (Table 15). Further, appearance photographs are shown in FIG. 3.

TABLE 15

| | | Addition | | | | | |
|---|---|---|---|---|---|---|---|
| | D50 | amount of | | | | | |
| | (μm) | preparation | L | a | b | hue | chroma |
| Example 19 | 1.86 | 0.75% | 58.31 | 34.60 | 22.59 | 33.14 | 41.32 |
| Example 37 | 1.87 | 0.75% | 57.35 | 34.06 | 22.45 | 33.39 | 40.79 |
| Example 38 | 2.09 | 0.75% | 56.87 | 34.64 | 22.05 | 32.48 | 41.06 |
| Example 39 | 1.89 | 0.75% | 56.77 | 34.72 | 22.07 | 32.44 | 41.14 |
| Example 40 | 2.42 | 0.60% | 57.27 | 35.12 | 22.02 | 32.09 | 41.45 |
| Example 41 | 2.14 | 0.60% | 56.98 | 35.28 | 22.49 | 32.52 | 41.84 |
| Example 45 | 2.02 | 0.60% | 58.16 | 32.87 | 22.05 | 33.85 | 39.58 |
| Comparative | 5.12 | 3.90% | 59.85 | 35.34 | 29.69 | 40.03 | 46.16 |
| Example 5 | | | | | | | |
| Comparative | 9.62 | 3.00% | 62.09 | 32.82 | 26.43 | 38.84 | 42.14 |
| Example 9 | | | | | | | |
| Comparative | 2.54 | 1.25% | 59.02 | 36.04 | 31.10 | 40.79 | 47.60 |
| Example 10 | | | | | | | |
| Comparative | 4.62 | 0.75% | 60.83 | 25.59 | 14.13 | 28.91 | 29.23 |
| Example 11 | | | | | | | |

It was confirmed that in Examples 19, 37 to 41, and 45, the hue is 25 to 34, a red color is exhibited, and also the color tone is bright.

On the other hand, it was confirmed that in the paprika emulsified dye preparation (Comparative Example 11) having a D50 of 4.62 μm, the chroma (color development) is low and the a value and the b value are also low. In Comparative Example 11, the emulsification stability was also insufficient.

PTL 1 describes that the color tone was reddish orange when the average particle diameter was 5 microns, and therefore, when the color was evaluated for Comparative Example 5 (D50=5.12 μm), the hue exceeded 40.

PTL 2 describes that the color tone was reddish orange when the average particle diameter was 10 microns, and therefore, when the color was evaluated for Comparative Example 9 (D50=9.62 μm), the hue exceeded 38.

Further, it was confirmed that in Comparative Example 10 (PTL 3), the hue exceeds 40. While not wishing to be bound by theory, in Comparative Example 10, it is considered that the color density per mass percent of the oil phase being about 1400 CV is one of the factors that the hue exceeded 40.

1. A paprika emulsified dye preparation, comprising a paprika dye, an oil-based solvent, water, and an emulsifier, and having the following characteristics:
a color density per mass percent of an oil phase is 1500 CV or more;
a volume-based median diameter (D50) of emulsified particles is 1 to 3 μm; and
a hue is 25 to 34.

2. The preparation according to claim 1, characterized by further having a chroma of 30 to 44.

3. The preparation according to claim 1, wherein the emulsifier is at least one type selected from the group consisting of gum arabic, a sucrose fatty acid ester, a sorbitan fatty acid ester, a glycerol fatty acid ester, a polyglycerol fatty acid ester, polyglycerol polyricinoleate, lecithin, gum ghatti, and low-molecular weight gum ghatti.

4. The preparation according to claim 1, wherein a content of the oil phase with respect to the total amount of the paprika emulsified dye preparation is 10 to 40 mass %.

5. A method for producing a paprika emulsified dye preparation, comprising:
a step of mixing a paprika dye and an oil-based solvent, thereby preparing an oil phase having a color density per mass percent of the oil phase of 1500 CV or more; and
a step of mixing the oil phase and an aqueous phase containing water and an emulsifier, thereby preparing emulsified particles having a volume-based median diameter (D50) of 1 to 3 μm.

6. The method according to claim 5, wherein the emulsifier is at least one type selected from the group consisting of gum arabic, a sucrose fatty acid ester, a sorbitan fatty acid ester, a glycerol fatty acid ester, a polyglycerol fatty acid ester, polyglycerol polyricinoleate, lecithin, gum ghatti, and low-molecular weight gum ghatti.

7. The method according to claim 5, further comprising adding an oil-soluble emulsifier when preparing the oil phase.

8. The method according to claim 5, wherein the oil phase and the aqueous phase are mixed so that a content of the oil phase with respect to the total amount of the paprika emulsified dye preparation is 10 to 40 mass %.
